(19) United States
(12) Patent Application Publication
(10) Pub. No.: US 2022/0095552 A1
(43) Pub. Date: Mar. 31, 2022

(54) METHODS FOR CULTIVATION USING PROTECTED GROWING WELLS AND RELATED STRUCTURES

(71) Applicant: Cambridge Research & Development, Inc., Nashua, NH (US)

(72) Inventors: Kenneth D. Steinberg, Nashua, NH (US); Jason W. Clark, Milford, NH (US)

(21) Appl. No.: 17/038,939

(22) Filed: Sep. 30, 2020

(51) Int. Cl. A01G 13/04; A01G 25/16; A01G 13/02

(52) U.S. Cl. CPC A01G 13/04; A01G 13/0212; A01G 25/16

(57) ABSTRACT

Methods and devices for growing plants in non-native environments and/or protecting crops from adverse weather conditions are disclosed in which sub-surface growing wells are used. The sub-surface growing wells extend below ground-level and include an opening that is exposed to above-ground conditions. The growing wells are outfitted with a well cap positioned above the well opening and the well cap can be moved either down to seal off the well from above-ground conditions or up to expose the well to above-ground conditions. The growing wells can be enhanced with a variety of control and monitoring systems to provide optimal growing conditions for plants contained in the wells.

### FIELD

This disclosure relates to structures and methods of growing plants, shrubs, and trees. Specifically, the disclosure describes structures and methods to provide protection and to take advantage of natural field conditions to enhance production and expand growing geographies for certain varietals.

### BACKGROUND

The planet possesses a wide array of plant life ranging from simple lichens to vast towering trees. Plants survive and thrive in some very diverse and sometimes inhospitable environments. Plants can be found growing in crevasse in the sides of mountains, under stones at altitudes few humans can endure, on the ocean floor and in our backyards.

Botanists and horticulturalists have spent decades studying and classifying every known plant species on the planet, classifying them into a set of codes that allows for every plant to be described with one specific name, for reference globally though the International Code of Botanical Nomenclature (ICBN). As part of this ongoing study, scientists and farmers have developed very specific criteria for the cultivation of most cultivated and uncultivated plants, with obvious emphasis placed on cultivated plants as these plants are commonly part of the planet's food supply.

As Nature will often do, some plants have characteristics that make them extremely sensitive to certain climates and conditions. Typical examples would include coffee or banana plants, which can only thrive in highly specific conditions. The ability to cultivate either of these plants in non-indigenous regions rarely results in satisfactory yields. Many plants have a number of conditions that make them productive in only select regions of the world. Some of these critical conditions include: temperature, humidity, duration of sunlight exposure, intensity of sunlight exposure, access to specific soil nutrients, soil conditions, access to water, specific pollination processes (insect, wind, etc.), air flow, air mixture, symbiotic animal, microbial, plant life, and seasonal changes. This is just a partial list of the conditions that could affect the growth, health, and production of a plant. Some plants are more tolerant and adaptable to a wider range of conditions while others are very particular.

Due to the changes in our climate and the rising cost of transportation, as it relates to importing crops, many botanists have tried to develop systems and solutions that would allow farmers to grow certain crops in non-indigenous locations. Many plants are now grown in greenhouses year-round while others have been genetically modified to survive in less than ideal environments. Unfortunately, not all plants lend themselves to greenhouse growth or genetic manipulation. Some plants have growing requirements that are so specific that previous efforts to grow them in cultivated environments have not yielded positive results.

### SUMMARY

This disclosure addresses the problem of satisfying difficult cultivation requirements to permit finicky plants to grow in non-indigenous environments. Various methods are described herein by which plants not previously capable of being grown outside of very select regions can now be cultivated in other locations that were once considered subpar or required significant capital investment and incurred overhead that made the farming of said plant unreasonable in any location other than the plant's natural habitat.

The present disclosure, in some respects, relates to a method by which certain types of plants can be grown in non-indigenous climates in a manner that provides many specific growing requirements. The presently disclosed methods involve the use of growing wells placed in locations that provide ample sunlight and natural ground water integrated with the necessary monitoring and cultivating systems that foster proper growth and provide protection for the plant. Structures and systems are also disclosed that facilitate the presently disclosed methods.

As mentioned, many plants need specific growing conditions to thrive. These particular growing conditions can rarely be found, in some instances. To help address some of these needs, the disclosure uses a variety of techniques to mitigate and/or provide an optimal growing environment while taking advantage of the helpful natural conditions available. The disclosure also addresses specific techniques and devices relating to, but not limited to: control of sunlight, access to water, protection against the elements, and/or nutrient supply. The disclosure also describes methods that can enhance monitoring and control systems via the use of alternative energy.

Many growing locations that provide temperatures, water, and sunlight necessary to grow some plants also have the unfortunate coincidence of being locations that are at high risk of experiencing damaging storms. Locations such as Florida or Texas regularly suffer from the impact of tropical storms, which bring high winds known to not only damage plants but literally dislodge them from the soil. While these latitudes are optimal for growing, the impact of replanting crops on a regular basis makes these locations untenable for long term profitable farming.

Moreover, there are many plants that take years to mature before they bear fruit. Damage to farms maintaining these crops takes years to recover and would likely cause the failure of a farm after just one storm. Even if the plants are not destroyed by the high winds, many plants will have limbs and leaves torn from their trunks and branches, rendering them useless until the damage has time to heal.

To mitigate damage from high winds and other undesirable elements, specially designed growing wells are described herein. As used herein, the term “growing well” refers to an open cellar dug into the ground at a depth appropriate for the growing height of the intended plant. The disclosed growing wells can be dug such that the top of the well wall protrudes above the ground at a height that would mitigate any potential flooding (e.g., likely no more than a foot or so in most instances, depending on the location of the well). The well can be lined with one or more materials, such as concrete. If present, the well liner(s) can be selected to make the well watertight while also providing sufficient strength to maintain wall integrity, provide earthquake stability, and/or support for internal structures, such as ladders and working platforms. The well wall can also serve as a place to anchor support for the plants in the well while they grow, if needed.

By digging these wells, a subterranean growing environment is provided that is open to the sky, allowing fresh air and sunlight to shine on the plants, while also protecting the plants against high wind and flood conditions. The disclosed wells, when dug, can be built at a width and depth that supports the grower's desire for plant count but also allows sufficient sunlight to reach the bottom of the well. It is important to note that wells that are dug too wide may require extra internal structures to support working platforms and plant support systems. The depth and length of each growing well can be determined by the available growing geography, among other relevant considerations.

A grower might decide to use multiple growing wells, in which case space can be provided between rows or blocks of growing wells such that there is room to navigate between the wells while walking on the ground's surface. Space between wells can also be included to accommodate harvesting equipment, electronics, and/or mechanical structures, if desired.

When constructing the wells, for the purpose of drainage and water filtration, drainage channels can be built around the outside of the wells. Like with traditional construction, these wells, like the foundation of a house, can benefit from a surrounding layer of material to aid in the flow of water around the outside of the well and protect the well walls against damage from the movement of natural elements such as rocks in ground freeze situations. Additionally, the wells can be wrapped or coated in watertight materials to control seepage of ground water into the growing well.

To address the need for water, the disclosed structures can utilize the natural water table to supply water for the plants in the well. In some embodiments, the wells are dug in geographical locations that have naturally high water tables so that water can be allowed to flow into the well by the control of baffles or valves placed in the wall of the well at or below the water table. With a high water table surrounding the growing well, the grower can use natural ground water to water the plants without having to rely on pumping or pressurized lines to supply water to the well.

In some embodiments, one or more water control valves are placed in the wall of the well, at various heights and distances, that can be manually or electronically controlled to allow ground water to enter the growing well. Such configurations can provide precise control of water and allow the grower to use soil or water-based (hydroponic) growing approaches.

To control the amount or level of water in the well, pumps can be placed in or around the well to be used to pump out excess water either via the top of the well or via valves placed in the wall of the well. These may be additional valves used solely for the extrication of water or part of the water intake valves, if the valves allow for bidirectional water flow.

As previously mentioned, the disclosed growing wells protect the plants within against high wind and can also utilize existing ground water. To address the need to control sunlight intensity and duration, well caps can be placed over the top of the well. The well caps may be constructed in a convex manner to provide additional strength and cause any excess rain or debris to be displaced outside of the well. In some embodiments, well caps can be mounted on one or more mechanical systems that position a well cap over each well while also allowing air to flow into and out of the well. Such embodiments can provide natural airflow to the well to mitigate mold, mildew, contribute to CO₂/O₂ mixtures and provide access for pollinators. The caps also can be lowered to seal the top of the wells should storms, high wind, or other adverse environmental conditions occur. When the conditions improve, the caps can be reopened by raising them back into position for normal growing conditions.

The well caps can, in some embodiments, be removably attached to a movement control mechanism that allows the caps to be removed should wider access to the growing wells be needed for activities such as maintenance or harvest. One or more well caps can be removed independently to provide full or limited access to the growing wells, as desired.

The well caps can also be designed to act as light control mechanisms, in some embodiments. For example, the panels covering the internal structure of the well caps can be built with light diffusing material that encourages light striking the cap from any angle to diffuse throughout the interior space of the growing well, maximizing the spread of light within the well. In these and other embodiments, the caps may have fixed or removable light-blocking material that can be attached to the inside/underside of the well caps, for example, with adhesive or hook and loop fasteners. In embodiments in which well caps include removable light-blocking material, the amount of diffused light projected into the well can be controlled by adding or removing light-blocking material to provide the desired amount of light transmission into the well. The ability to control the amount of light in each well can be used to mimic the natural growing environments of plants that grow under the canopy of other plants, if appropriate.

As will be appreciated upon consideration of the subject disclosure, adjustable light-blocking well covers (or caps) can allow a grower to change the amount of light projecting into a well to provide the appropriate amount of light for different types of plants being grown, accounting for changes in seasonal sunlight and heat. The grower can also control the amount of sunlight in the well by simply modifying the configuration of the light blocking covers as needed. For example, more light could be blocked during an intense summer season or more light could be permitted into the well during a cold winter, if desired.

Various structural features can be incorporated into the growing wells to facilitate the safe cultivation and harvesting of the plants. For example, notches can be formed on the inside of the top of the well walls to support vertical ladders and supports. In these and other embodiments, horizontal platforms can be laid across the width of the well on rungs resting on vertical supports in the well. These platforms can allow farmers to stand at any height and location within the well as the platforms can be moved along the vertical rungs on each side of the well as needed. In some embodiments, specialized platforms can be constructed with a circular hole in the middle though which the plant can grow. These holes, if present, may allow a plant's root ball to be hung from below the platform, using adjustable support straps, while allowing the upper portion of the plant or tree to be supported by straps strung between the platform and tree trunk to keep the trunk vertically aligned.

The platforms, if present, may also provide access for harvesting and care of the plant(s) in the well. For example, these platforms can be left in place or moved within the well as necessary to provide full access to any space within the well. The platforms can also be enhanced with collapsible side rails to mitigate the risk of falling.

In some embodiments, the disclosed wells may have variable depth capability by either intentionally digging the wells at different depths or by putting risers within the base of the wells to accommodate different plant types. In some such embodiments, the risers may be manually inserted or raised via mechanical devices, even to the point of making the wells work at ground level, if appropriate. By having automated well risers, plants could be raised up to various levels to allow for ground level maintenance, harvesting, access to pollinators, and/or natural elements. Risers, if present, may also allow for combining different plants of differing needs in the same growing well.

In some embodiments, the disclosed growing wells may be used to grow a combination of plants and animals. For example, with the use of hydroponics, fish may be cultivated along with plants in the disclosed growing wells, using the same water system for both growing and nurturing both plants and fish. In some such embodiments, symbiotic growing conditions may increase profitability by creating two products simultaneously using shared resources.

In further embodiments, the growing wells could be used for traditional planting, forgoing the use of hydroponics for soil-based farming. In some such embodiments, ground water entering the wells from the water table may then be used to water the plants and the well system (i.e., caps, walls, etc.) may be used to protect the plants during hostile weather. This type of configuration may, in some embodiments, limit crop damage due to the avoidance of high wind, flooding, frostm and other conditions that can negatively impact yields.

In further embodiments, plants grown in the disclosed growing wells may be rotated by season or plants may be moved to allow for the use of the wells throughout various seasons. This could increase the yield per acre and allow a farmer to rotate crops as demand and weather allow.

In select embodiments, the area in and around the growing wells may be supplemented with the inclusion of pollination species to accommodate the pollination needs of the plants in and around the growing wells. While traditional farming methods may include the use of pollinators at ground level, habitats for pollinators may be included in the disclosed growing wells to suit plant needs but also to protect the pollinators from adverse environmental conditions present at ground level. This approach may also prolong the growing season, especially if the wells maintain better climates for the pollinators either year-round or for longer seasons.

In yet further embodiments, farmers may combine above and below ground farming techniques to accommodate various production needs and desires. For example, in some embodiments, growing wells may be configured to enhance combined growing techniques. In some such embodiments, both above and below ground combination growing techniques may be used. Combination growing techniques may be used to support plants during various stages of maturation. For example, young, fragile plants could be grown in the wells and then moved to ground level groves as they become more mature. The inverse is also possible whereby plants may be grown above ground, in transportation chambers, and then moved into the wells as required.

In some embodiments, power may be provided to electronic devices supporting the growing well(s). In some such embodiments, power can be provided by utility power service and/or renewable energy sources, depending on availability (i.e., access to solar, wind, and/or hydroelectric power). The power generated from these sources can be stored in batteries and/or use directly as needed.

In select embodiments, solar panels may be built into the well caps, allowing the well caps to provide both power storing and shielding functions to the underlying growing wells. In some such embodiments, using the well caps both as a protective covering for the wells and as a framework for mounting solar panels, the cost of additional materials can be reduced or eliminated, and easy panel access can be provided. The panels may, in some embodiments, be designed to disconnect from the power circuit in a manner that does not interrupt the flow of solar power from the other panels.

In further embodiments, to extend the growing period and/or account for days with diminished sunlight, additional lighting sources mounted inside the growing wells may be utilized. These light sources may be manually or electronically controlled, allowing the grower to provide additional light or to emulate differing growing seasons/patterns as desired.

In some embodiments, additional reflective surfaces may be installed outside or inside the growing wells to provide additional lighting in the growing wells during times when the angle of the sun in the sky is lower to the horizon. In some such embodiments, reflectors or prismatic collectors may be used to redirect sunlight to the plants in the well.

In yet other embodiments, HVAC systems may be installed to provide either heating or cooling within the wells. This may allow growers to curate preferred growing conditions and to emulate seasonal changes that are often needed for proper growing cycles.

In some embodiments, robotic pruning and harvesting components may be introduced to the wells. If present, the robotic pruning or harvesting components may be mounted on internal structures to allow for ongoing care and occasional harvesting of crops without direct intervention of humans.

In further embodiments, groundwater may not flow directly into each well via sidewall vents but, instead, may be captured by a water processing system that would then process and provide the groundwater to the growing wells via a plumbing system. In some such embodiments, use of a water processing system may allow a grower to condition the water as needed to meet specifications for particular crops.

In other embodiments, pressure activated air valves may be added to the disclosed growing wells to control wide pressure differentiations caused by weather events. In some such embodiments, when the caps are closed to protect the plants in the well, there exists the potential for a blowout if the pressure outside of the well significantly rises or drops. To equalize the pressure without introducing turbulence, pressure control valves can be used to mitigate pressure differences, in some embodiments.

In further embodiments, airflow values may be included in the growing wells to increase the flow and mixture of CO₂ and Oxygen. Airflow valves may be particularly useful in situations when the well cap is closed. Specifically, closure of the well caps for an extended period of time may lead to an imbalance of gases and airflow valves and blowers may be helpful to circulate and rebalance the mixture of gases inside the growing wells.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates a map of the world marked to identify the geographic regions in which cocoa can be grown.

FIGS. 1B-1C illustrate specific growing regions for a graphically limited crop. In particular, FIG. 1B illustrates the current growing regions in the Ivory Coast and Ghana for cocoa production and FIG. 1C illustrates the projected growing regions in these countries by the year 2050.

FIGS. 2A-2D illustrate exemplary plants experiencing different conditions that can contribute to limited crop geo-diversity. For example, FIG. 2A illustrates a plant experiencing high winds; FIG. 2B illustrates a plant experiencing improper sunlight exposure; FIG. 2C illustrates a plant experiencing improper heat and humidity; and FIG. 2D illustrates a plant experiencing improper water conditions.

FIGS. 3A-3B depict features of exemplary growing wells, configured in accordance with some embodiments of the subject disclosure. In particular, FIG. 3A illustrates a cross-sectional view of an exemplary growing well and FIG. 3B illustrates a perspective view of multiple plants positioned in an exemplary growing well.

FIG. 4 illustrates an exemplary growing well configured to grow plants hydroponically.

FIG. 5 illustrates an example control and power system that can be used in connection with the disclosed growing wells.

### DETAILED DESCRIPTION

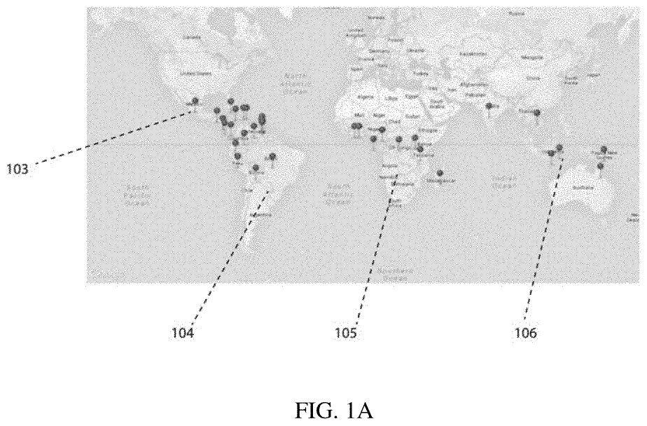

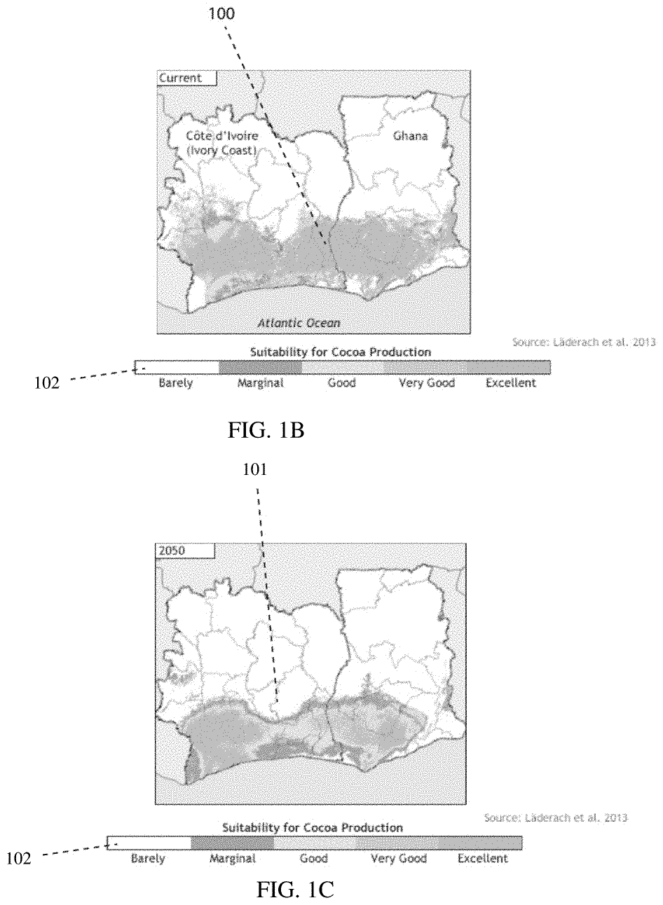

Referring now to FIG. 1A, there is shown a map of various geographical regions in which certain crops can be grown. Specifically, the map of FIG. 1A shows the restricted geography in which Cocoa is grown. Cocoa is very particular with respect to certain environmental conditions required to grow productively. Currently, in the world, the primary regions in which Cocoa is grown are restricted to Central America 103, South America rain forests 104, regions of Central Africa 105, and some limited geographies in Asia Pacific 106.

Furthermore, some of the indigenous regions in which certain crops currently grow are shrinking due to climate change and man-made incursions. The regions in which crops like coffee, bananas, and cocoa are grown shrink annually.

FIG. 1B illustrates the current growing regions in the Ivory Coast and Ghana for cocoa production and FIG. 1C illustrates the projected growing regions in these countries by the year 2050. As is shown in the map of the Ivory Coast/Ghana 100, the current land available for Cocoa farming is shrinking 101 as climate change 102 affects the regional climate. This reduction in viable lands contrasts with the increase global demand for crops like cocoa. Unfortunately, many of these geo-selective crops have such specific growing needs that the ability to grow them in other regions of the world has been and continues to be unsuccessful.

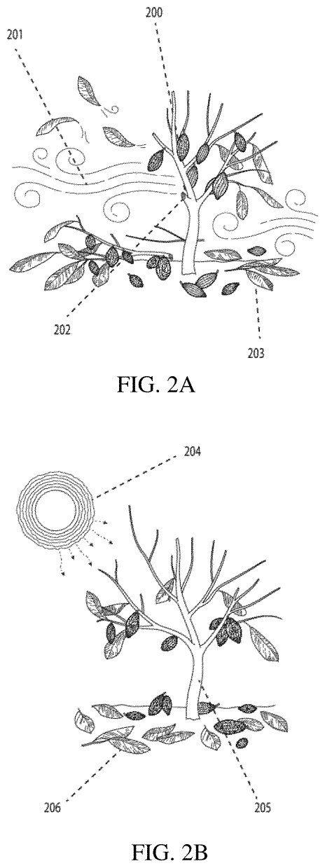

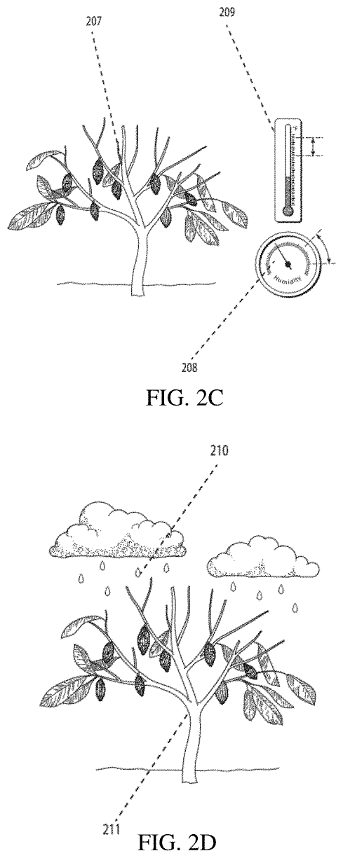

Referring now to the plants illustrated in FIGS. 2A-2D, several conditions that contribute to the inability of certain crops to function in non-native geographies are depicted. As shown in FIG. 2A, some plants 200 are very susceptible to high winds 201 that cause damage 202 and loss of plant matter 203. Often such plants 200 must grow under the protection of other plants or natural wind barriers.

As shown in FIG. 2B, some plants 205 are susceptible to sunlight 204, whether it be too much or too little. Improper sunlight exposure can cause plants to suffer stress and lose plant matter 206.

As shown in FIG. 2C, other plants 207 require very specific levels of heat 209 and humidity 208 to thrive. High or low temperature conditions can cause a lack of production for the plant or the loss of production due to crop or plant damage. This is commonly seen when cold weather strikes warmer climates, causing fruit and vegetables to incur frost damage.

Lastly, some plants 211 require significant amounts of water 210 in order to produce, as shown in FIG. 2D. Without natural water sources, farmers have to spend capital and time bringing water to the plants in order to support production.

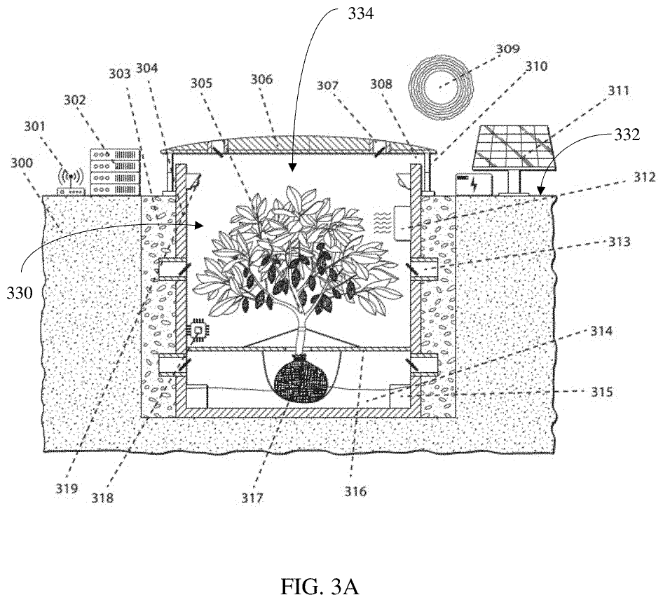

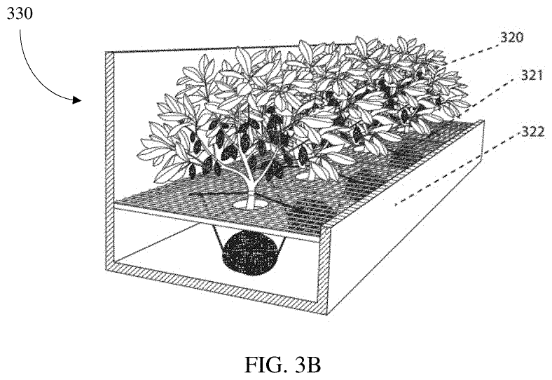

The presently disclosed and described growing wells as well as supporting devices and related methods advantageously permit sensitive plants, such as cocoa plants, to be grown in regions other than those currently known to be suitable for unaided growth at ground level. FIG. 3A illustrates a cross-sectional view of an example growing well 330 and FIG. 3B illustrates a perspective view of plants arranged in an example growing well as presently disclosed. As shown in FIG. 3A, the growing well 330 is formed at least partially below ground-level 332. The well 330 also has an opening 334 that extends to or extends above ground-level 332 and one or more walls 304 extending below ground-level 332. In some embodiments, the one or more walls 304 of the well 330 also extend at least partially below a water table under ground 300.

In some embodiments, the well 330 has a circular cross-section and includes a single wall 304. However, in other embodiments, the well 330 has a triangular, rectangular, or other polygon-shaped cross-section with three or more walls 304. Similarly, the well opening 334 may be circular, triangular, rectangular, polygon shaped, or irregularly shaped. Numerous configurations are possible and contemplated herein.

As shown in FIG. 3A, the well 330 extends below ground 300 using walls 304 to create hollowed out space(s) in which crops 305 can be grown. The wall(s) 304 of the growing wells 330 may, in some embodiments, be configured to protrude above the ground 300 in order to protect against any additional material or water falling into the well 330 and as supports for the well cap 306 (discussed in detail in later paragraphs) when closed. The depth of the growing well 330 may be selected based on the overall mature plant height.

The growing wells 330 may be dug in geographies with a relative high water table. In some such embodiments, the wall(s) 304 may include one or more water flow vents 313 formed in the wall(s) 304 to control the flow of water into the well bottom 314. For example, in some embodiments, one or more water flow vents 313 may be formed in the well wall 304 at a position below the water table. In these and other embodiments, the one or more vents 313 may be adjustable to both allow water from the water table to flow into the well 330 and to prevent water from the water table from flowing into the well 330.

In some embodiments, crushed stone 303 or another type of silt filtering material may be positioned adjacent to the one or more walls 304 to keep the water flow vents 313 from clogging. Water let into the well 330 can be used to grow plants via hydroponics 317 or soil-based techniques. Water levels in the growing well 330 may, in some embodiments, be controlled by a combination of the natural consumption of the plant, evaporation, and pumps 315 placed in the base of the growing well. If present, one or more pumps 315 may be configured to adjust the amount of water present in the well 330.

Above the opening 334 of the well 330 is a removable cap 306. Cap 306 is configured to move between a first position in which the cap 306 is directly in contact with the one or more walls 304 and a second position in which the cap 306 is positioned at a distance above the one or more walls 304. In some embodiments, the cap 306 may be at least one foot, two feet, three feet, or more above the one or more walls 304 when in the second position.

As shown in FIG. 3A, in some embodiments, struts 310 may be used to move cap 306 from between the first position and the second position. Specifically, if present, struts 310 may be used to raise and lower the cap 306 with respect to the well 330. Being able to move cap 306 to effectively open and close the well 330 to above-ground variables can be very helpful. For example, cap 306 can be closed during unsafe environmental situations but raised during normal growing conditions to affect air flow and to allow pollinators access to crops.

In some embodiments, cap 306 may include one or more air vents 307 which can be opened to equalize air pressure and allow for additional air flow when required. Cap 306 may, in some embodiments, be implemented with a transparent or opaque material, as desired. The material used to form cap 306 can be selected to either filter or capture light 309, which can provide both light control and redirection capabilities for cap 306.

Cap 306 may, in some embodiments, be configured to imitate natural growing conditions of certain plants that grow in the cover of other crops, for example, Cocoa which grows in the cover of tree groves. Using a cap 306 with light filtering capabilities can reduce the cost and maintenance associated with having to grow additional plants for light filtration purposes. In some embodiments, the cap 306 may be couplable to light-blocking material to allow for adjustable light transmission to the well 330. In these and other embodiments, cap 306 may be fitted with one or more solar cells to provide for additional solar energy collection.

In some embodiments, moveable platforms 316 may be positioned inside the well 330. Moveable platforms, if present, may be used for a variety of functions such as, for example, support structures for the crops and walking platforms for harvesting. Moveable platforms 316 may, in some embodiments, fit into hooks set into the wall(s) 304 of the growing wells 330, thereby allowing the platforms 316 to be positioned and/or moved both vertically and horizontally within the well.

In some embodiments, the growing wells 330 may be fitted with one or more sensors 318 and/or cameras connected to control systems 302, which may be used to monitor the conditions inside and outside of the growing well 330. If present, these control systems 302 can be remotely accessed via a network 301 as needed. In some embodiments, heating and chilling systems 312 may be placed in the growing well 330 to offset extreme temperature conditions and keep the crops at optimal growing temperatures. For low light conditions, additional lighting 319 can also be provided in the well 330, as shown in FIG. 3A. Power for the devices/systems present in well 330 can be supplied by either normal utilities or alternative energy sources, such as solar 311.

The disclosed growing wells 330 can be designed to hold individual plants or constructed to hold multiple plants in a single well 330. FIG. 3B illustrates a perspective view of an example well 330 configured to hold multiple plants 320. As shown in FIG. 3B, well 330 includes a divider 321 to provide separation and support for plants 320. FIG. 3B also shows an internal wall 322 that surrounds plants 320 within well 330. In some embodiments, internal wall 322 may be positioned within wall 304 or, in other embodiments, internal wall 322 may serve as the only wall separating the ground 300 from the well 330. In embodiments in which internal wall 322 separates the ground 300 from the well 330, internal wall 322 may have any of the features previously described herein with respect to wall 304.

It should be appreciated upon consideration of the subject disclosure that, in some embodiments, a plurality of wells 330 (and caps 306) as previously described herein may be used in tandem to facilitate plant growth on a large scale. In some such embodiments, water and climate control features within the wells 330 (as discussed in previous paragraphs) may each be in communication with a central control unit, which can be used to easily control conditions within the wells. Furthermore, in some such embodiments, caps 306 may each be mounted individually or mounted to a common structure to allow for individual or coordinated movement of the caps 306 relative to the wells 330. Numerous growing well arrangements are possible and contemplated herein.

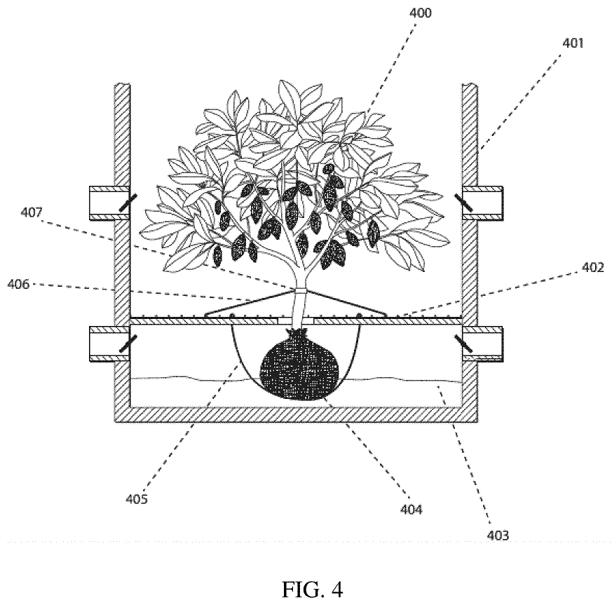

FIG. 4 illustrates a growing well 401 uniquely configured to hydroponically grow a plant using a combination of braces and straps. It should be understood that well 401 may have any combination of features previously discussed herein with respect to well 330. As shown in FIG. 4, well 401 houses plant 400. The plant rootball 404 is suspended under a platform 402 which has an opening in it to allow the plant 400 to grow vertically and for the trunk to expand as the plant matures. As shown in FIG. 4, the rootball 404 may be suspended under the platform 402 with a set of adjustable straps 405 which allow the grower to change the amount of the rootball 404 that comes in contact with the water 403. Above the platform is another set of adjustable straps 406 which are connected to an expandable, low-friction collar 407. These straps are used to maintain the vertical orientation of the tree as it grows since there is no soil to act as a stabilizing medium for the roots.

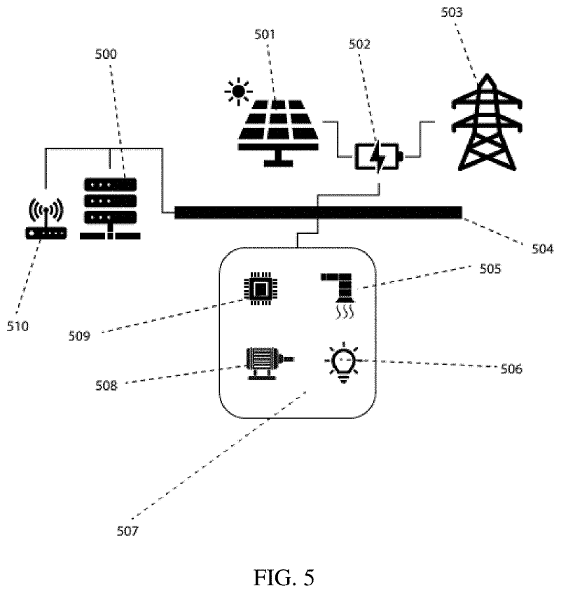

FIG. 5 illustrates an example control and power system that can be used in connection with the disclosed growing wells 507. It should be appreciated that the features illustrated in FIG. 5 could be used in connection with any type of growing well discussed herein, such as growing well 330 and/or 401. As shown in FIG. 5, within and around the growing well 507 there are a number of systems that are responsible for monitoring and maintaining the environments within the growing well 507. All of these systems are accessible via on-premise or remote networking interfaces 510.

Various sensors 509, including but not limited to, heat, humidity, light, video, water quality, and/or air quality can be used to constantly monitor any and all features of well 507. These sensors are connected to the control systems 500 for data analysis and collection.

For situations in which the weather conditions might fall outside of optimal growing conditions, HVAC systems 505 for heating and cooling may also be included in well 507. For example, heat can be supplied in case of adverse cool weather and cooling can be provided when heat exceeds required norms. If present, these HVAC systems may also be connected to the control systems 500 for data analysis and collection.

In situations where the water level in the growing well 507 must be increase/decreased and/or nutrients provided, pump and mixture systems 508 can also be introduced into the growing environment. These mechanical systems may also be connected to the control systems 500 for data analysis and collection.

When the amount of natural light in the well 507 is reduced for extended periods of time, additional lighting may be provided by including artificial light 506 in the growing environment. These lighting systems may also be connected to the control systems 500 for data analysis and collection.

All of the systems and devices shown in FIG. 5 may be powered by either standard utility power 503 or alternate energy sources 501, which can be used directly or via battery storage and power conditioning systems 502.

### Examples

There are numerous ways in which the disclosed devices and methods can be used to enhance current growing methods or support the growth of plants in non-native environments.

One exemplary use case is growing cocoa within the borders of the continental United States. There are several locations, such as Florida, where the conditions for growing cocoa are ideal if there could be a way to mitigate the negative effects of the intense sunlight and the ever-present threat of a crop-destroying storm. Florida also has a very high water table of fresh water, which can be used to reliably provide water to water-reliant crops, such as cocoa plants.

Another exemplary use case is applying the disclosed devices and techniques to cultivate citrus crops, which are frequently damaged by either storms or bouts of cold weather. These adverse weather conditions can be mitigated by the disclosed growing wells, saving farmers millions of dollars in lost revenue due to crop damage. Numerous other possible uses for the presently disclosed devices and techniques will also be apparent to one skilled in the art upon consideration of the subject disclosure.

What is claimed is:

1. A device for growing plants, the device comprising:
a well formed at least partially below ground-level, the well having an opening extending to or above ground-level and one or more walls extending below ground-level;
a well cap positioned above the well opening, wherein the well cap is configured to move between a first position directly in contact with the one or more walls and a second position at a distance above the one or more walls; and
a vent formed in the well wall, wherein the vent is adjustable to allow water to flow into the well and to prevent water from flowing into the well.

2. The device of claim 1, wherein the well includes one wall having a circular cross-section.

3. The device of claim 1, wherein the well includes at least two walls.

4. The device of claim 1, wherein the one or more walls extend at least partially below a water table and the vent is formed in the well wall below the water table.

5. The device of claim 1, wherein the well wall includes at least two vents.

6. The device of claim 1, wherein the cap is at least one foot above the one or more walls when in the second position.

7. The device of claim 1 further comprising at least one strut configured to move the cap between the first position and the second position.

8. The device of claim 1, wherein the cap is implemented with a transparent or an opaque material.

9. The device of claim 1, wherein the cap is convex.

10. The device of claim 1 further comprising a pump positioned in a base of the well, wherein the pump is configured to adjust an amount of water present in the well.

11. The device of claim 1 further comprising at least one moveable platform positioned horizontally or vertically within the well.

12. A plurality of devices as recited in claim 1.

13. A growing well for hydroponically growing a plant, the growing well comprising:
an underground structure having at least one wall, wherein the underground structure is configured to internally retain water;
a horizontally-oriented platform affixed to the at least one wall of the underground structure, wherein the horizontally-oriented platform has an opening formed to accommodate a trunk of the plant;
a first set of adjustable straps affixed to the platform and extending underneath the platform, wherein the set of adjustable straps is configured to support a rootball of the plant; and
a second set of adjustable straps affixed to the platform and extending above the platform, wherein the second set of adjustable straps are connected to a collar sized to fit around the trunk of the plant.
